(19) United States
(12) Patent Application Publication
(10) Pub. No.: US 2005/0089688 A1
(43) Pub. Date: Apr. 28, 2005

(54) Polyphenylene sulfide composition and application

(76) Inventors: Vincent A. Mungioli, Rochester Hills, MI (US); Craig Andrews, Brighton, MI (US); David A. Soules, Bartsville, OK (US); Jay G. Blackburn, Kingwood, TX (US); William E. Sattich, Bartlesville, OK (US); Robert M. Goodman, The Woodlands, TX (US)

Correspondence Address: Michael G. Fletcher;FLETCHER YODER, P.O. Box 692289, Houston, TX, 77269-2289, US

(21) Appl. No.: 10/922,139

(22) Filed: Aug. 18, 2004

Related U.S. Application Data
(60) Provisional application No. 60/496,097, filed on Aug. 18, 2003.

(51) Int. Cl. C08K 3/10; B32B 27/30; B32B 27/00

(52) U.S. Cl. 428/411.1; 524/445; 524/449; 524/435; 524/502; 428/500; 428/522

(57) ABSTRACT

A composition and application are presented for a polyphenylene sulfide (PPS) based blend. The PPS-based blend may comprise about 40 to 95% by weight of a PPS resin and about 5 to 60% by weight of an olefinic copolymer and an elastomer. The PPS-based blend has improved impact resistance, elongation at break and flexibility compared to PPS and may be used in the construction of articles where these properties are desired in addition to properties typically associated with PPS. The PPS-based blend may be incorporated as a terminal layer in a multi-layer material which may be used in the formation of articles of manufacture, including the individual pieces of a multi-piece article. When assembled such that the PPS-based layers are joined, the resulting PPS-based article may possess vapor and liquid impermeability throughout, including at the junctions of the respective constituent pieces.

### CROSS-REFERENCE TO RELATED APPLICATIONS

This application claims priority to provisional application 60/496,097, filed on Aug. 18, 2003.

### BACKGROUND OF THE INVENTION

1. Field of the Invention

The present technique relates generally to elastomeric polyphenylene sulfide (PPS) compositions with improved flexibility properties relative to PPS. In particular, the present technique relates to elastomeric PPS compositions that are useful as a flexible coating, fiber, or barrier.

2. Description of the Related Art

This section is intended to introduce the reader to various aspects of art which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as any indication of what subject matter may constitute prior art to the present invention.

Thermoplastic polymers, such as plastics and other polymers which may be molded or shaped when heated but which harden in the desired shape when cooled, are commonly incorporated into commercial and manufacturing goods and packages. Particular thermoplastic materials typically vary in their characteristics, such as their flame resistance, impact resistance, flexibility, chemical resistance, heat tolerance, and so forth. As a result, suitable thermoplastic materials are generally selected for an application based upon the demands or constraints of the application. Occasionally, however, a thermoplastic material that might otherwise be well suited for an application may be unacceptable because of an unsuitable characteristic.

For example, polyphenylene sulfide (PPS) is a high-performance engineering thermoplastic with good thermal stability, dimensional stability, chemical resistance, flame resistance, and which is electrically non-conductive. However, PPS may be too inflexible or stiff for some applications in which a high degree of flexibility, resilience, or impact resistance are desired. For example, the stiffness of PPS would generally preclude its use as a coating for substrates which must be bendable or conformable, such as for wires or cables, or as a component in the construction of containers or other articles which must be resistant to impact damage.

However, a PPS-based composition that was sufficiently flexible, resilient, or impact resistant and which possessed the other desirable qualities of PPS might be desirable for such uses. In particular, a PPS-based composition having greater flexibility and/or impact damage resistance relative to pure PPS is highly desirable. Similarly, articles or goods incorporating such a composition, either as a coating or as a structural component are highly desired.

### BRIEF DESCRIPTION OF THE DRAWINGS

Advantages of the invention may become apparent upon reading the following detailed description and upon reference to the drawings in which:

FIG. 1 illustrates a wire coated with a PPS-based blend, in accordance with one aspect of the present technique;

FIG. 2 illustrates a multi-layer structure incorporating a barrier layer, in accordance with one aspect of the present technique;

FIG. 3 illustrates the extrusion of a parison into a mold for blow molding, in accordance with one aspect of the present technique;

FIG. 4 illustrates the closing of the mold and the blowing of the parison of FIG. 3;

FIG. 5 illustrates the cooling of the blow-formed article of FIG. 4;

FIG. 6 illustrates the ejection of the blow-formed article of FIG. 5;

FIG. 7 illustrates a piece of a multi-piece article constructed from the multi-layer structure of FIG. 2, in accordance with one aspect of the present technique;

FIG. 8 illustrates a piece of a multi-piece article constructed from the multi-layer structure of FIG. 2, in accordance with one aspect of the present technique, after insertion of one or more inner components to be included in the finished article;

FIG. 9 illustrates a multi-piece article comprised of pieces such as those depicted in FIGS. 7 and 8, in accordance with one aspect of the present technique;

FIG. 9A illustrates a close-up view of the junction of two pieces comprising the multi-piece article of FIG. 9, in accordance with one aspect of the present technique;

FIG. 10 illustrates the formation of the piece of FIG. 7 via vacuum forming, in accordance with one aspect of the present technique;

FIG. 11 illustrates the assembly of a multi-piece article from the pieces of FIGS. 7 and/or 8 via hot plate welding, in accordance with one aspect of the present technique;

FIG. 12 illustrates the assembly of a multi-piece article from the pieces of FIGS. 7 and/or 8 after hot-plate welding or other adhesion or bonding techniques, in accordance with one aspect of the present technique; and

FIG. 13 illustrates a motor vehicle incorporating a fuel tank constructed, in accordance with one aspect of the present technique.

### DETAILED DESCRIPTION OF SPECIFIC EMBODIMENTS

A. Introduction

Thermoplastic blends based on polyphenylene sulfide (PPS) may be used in a variety of manufacturing, commercial, and/or consumer applications. In particular, crystalline PPS is a high-performance thermoplastic that may be used in the manufacture of a variety of articles in which the mechanical and/or electrical properties of PPS are desired. For example, PPS may be suitable for applications in which high modulus, stiffness, thermal stability, dimensional stability, chemical resistance, flame resistance, and/or electrical non-conductivity are desired. The PPS may be incorporated as a manufacturing component either alone or as a constituent of a thermoplastic blend, i.e., a composition of PPS and one or more other constituents, such as other thermoplastic materials, elastomeric materials, copolymers, resins, reinforcing agents, additives, and so forth.

In particular, use of thermoplastic blends may be advantageous when particular properties of a constituent, such as PPS, are desired though other properties of the constituent may be less desirable. Indeed, due to the wide variety of uses of thermoplastics, the development of suitable thermoplastic blends that accentuate the desired properties of a constituent of the blend while minimizing any undesired properties of the constituent are often desired for particular uses. For example, a PPS-based blend may be desirable as a coating for a flexible substrate, such as a cable or a wire, as a constituent of a fiber, such as may be woven into a cloth or textile product, or as a structural component in the construction of a container for storing volatile liquids. Therefore, it may be desirable to form a thermoplastic blend comprising a suitable grade and/or sufficient quantity of PPS to retain the desired chemical, electrical, thermal, and/or mechanical properties of PPS but also comprising one or more other constituents to impart the desired degree of flexibility and/or impact damage resistance to the blend.

B. Suitable PPS-Based Blends

An example of a PPS-based blend possessing improved flexibility and impact damage resistance compared to PPS and possessing substantial chemical, electrical, and/or flame resistance may be formed by combining a treated PPS resin, an olefinic copolymer, and an elastomer. The PPS-based blend may comprise about 40 to 95% by weight of the treated PPS resin, about 5 to 50% of the olefinic copolymer, and about 1 to 20% by weight of the elastomer. In one embodiment of the PPS-based blend the blend includes less than 10% by weight of the olefinic copolymer. The weight ratio of the olefinic copolymer to the elastomer typically is about 3:1 to about 20:1. As one of ordinary skill in the relevant art will appreciate, the quantities of the blend constituents are selected such that they total 100% by weight of the blend composition.

Prior to combination with the other constituents of the blend, the PPS may be treated to modify reactive end-groups, such as by acidifying the end-groups. In particular, it may be desirable to remove ionic species, such as sodium or chloride ions, associated with the reactive end-groups. This deionization process may be accomplished by a variety of techniques, including treatment of the PPS with acid, hot water, organic solvents, or some combination of these treatments. The deionizing treatments may be performed subsequent to polymerization and recovery of the PPS, such as on the wet PPS fluff or granules. The treatments may be carried out in the presence of heat and/or stirring, if desired, to improve the efficiency of the treatment. As described below, the deionizing treatment may also be accomplished prior to the termination of the PPS polymerization process, i.e., under polymerization conditions. After deionization, the ion content of the treated PPS, such as the sodium ion content, may be less than 900 ppm, if not less than 500 ppm.

The PPS to be treated may include PPS resins having a relatively low molecular weight as well as essentially linear polymers having a relatively high molecular weight. In some instances, such as with low molecular weight resins, the degree of polymerization of the PPS polymers may be increased by heating the PPS polymers in the presence of oxygen or in the presence of a crosslinking agent, such as peroxide, after polymerization. Although PPS prepared by any process may be employed in the present technique, it may be desirable to use a substantially linear polymer having a relatively high molecular weight for forming a PPS blend.

As used herein, PPS comprises at least 70 mole %, and generally 90 mole % or more of recurring units represented by the structural formula: 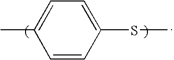
and may comprise up to 30 mole % of recurring units represented by one or more of the following structural formulas:

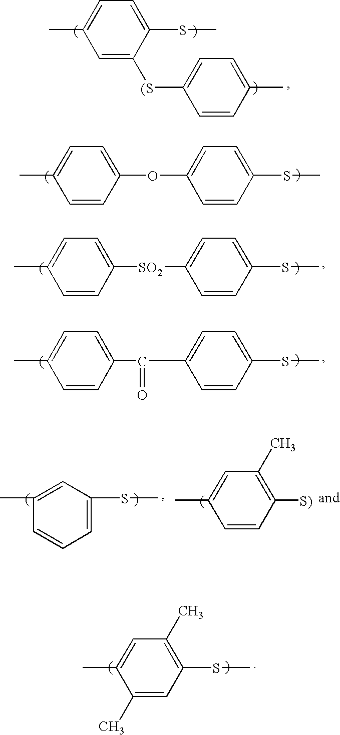

To improve the affinity of the PPS resin as described above for the olefinic copolymer, the PPS resin may be subjected to a deionizing treatment, as noted above. In general, the PPS to be treated is in the form of powdery particles, particularly fine particles, to facilitate the efficiency of both the treatment and any subsequent washing processes.

In regard to the acid treatment, the polymerized PPS, including recently polymerized or wet PPS, may be immersed in an acid or acid solution under suitable stirring or heating conditions. For example, an aqueous acetic acid solution with a pH of 4 may be used to treat PPS. The acetic acid solution may be heated to approximately 80° C. to 90° C. and the PPS immersed for approximately 30 minutes under stirring. The treated PPS may then be washed one or more times, such as with distilled or deionized water that may be heated up to 100° C. or higher under pressure. In general, acids which may be employed include those which do not decompose or deteriorate PPS. In addition to acetic acid, other examples of such acids include hydrochloric, sulfuric, phosphoric, silicic, carbonic, and propionic acids.

An organic solvent treatment may be employed instead of or in addition to the acid treatment to improve the affinity of the PPS resin for the olefinic copolymer. Treatment of the PPS by this technique may be accomplished by immersing the PPS in one or more organic solvents, with stirring and/or heat when suitable. The recovered PPS may be treated after washing and drying or while still wet with polymerization solvent or wash water. Indeed, the PPS polymerization mixture may be mixed with an organic solvent or solvents to treat the PPS. Temperature during treatment with the organic solvent may vary, depending on the solvent, from room temperature to approximately 300° C. Sufficient organic solvent treatment, however, can be obtained from approximately 25° C. to 150° C. Depending on the organic solvent and the temperature, the treatment may occur at high pressure to prevent boiling of the solvent. While the period of organic solvent contact is not particularly limited, generally the desired effects may be obtained by treating for approximately five minutes or more, either in a batch or continuous manner. After treatment, the PPS may be washed one or more times with distilled or deionized water, depending on the water solubility and boiling point of the organic solvent. The water wash, if performed, may be carried out at up to 100° C., or higher under pressure.

The organic solvent treatment is not limited in regard to organic solvents to the extent that the organic solvent does not decompose or deteriorate PPS. Examples of organic solvents include, but are not limited to, the nitrogen containing polar solvents (such as N-methylpyrrolidone, N,N-dimethylformamide, N,N-dimethylacetamide, 1,3-dimethylimidazolidinone, hexamethylphosphorylamide, piperadinone group, and so forth). Other possible organic solvents include, sulfoxide and sulfone group solvents (such as dimethyl sulfoxide, dimethyl sulfone, sulfolane, and so forth) and ketone group solvents (such as acetone, methyl ethyl ketone, diethyl ketone, and acetophenone). Additional possible organic solvents include ether group solvents (such as diethyl ether, dipropyl ether, dioxane, and tetrahydrofuran) and halide group solvents (such as chloroform, methylene dichloride, trichloroethylene, ethylene dichloride, perchloroethylene, monochloroethane, dichloroethane, tetrachloroethane, perchloroethane, chlorobenzene, and so forth). Alcohol and phenol group solvents (such as methanol, ethanol, propanol, butanol, pentanol, ethylene glycol, propylene glycol, phenol, cresol, polyethylene glycol, polypropylene glycol, and so forth) and aromatic hydrocarbon group solvents (such as benzene, toluene, xylene, and so forth) may also be employed.

In addition, the PPS may be treated with hot water, such as distilled or deionized water, to improve the affinity of the PPS resin for the olefinic copolymer. Hot water treatment may be performed using water which is 100° C. or higher. Water which is at 170° C. or greater may be more effective at providing the desired chemical modification. For example, a given amount of PPS, including wet or recently polymerized PPS, may be added to a given amount of water, which is then heated, e.g., to 170° C. or higher, and stirred in a pressure vessel. Though the ratio may vary, the ratio of PPS-to-water may generally be 200 g or less of PPS per liter of water. Typically, the water treatment is carried out in an inert atmosphere. After hot water treatment, the PPS may be washed one or more times to remove any undesired components.

While the above treatments may achieve deionization or acidification of the PPS end-groups, in some instances it may be desirable to achieve this process within the reactor under polymerization conditions. In particular, such a treatment may reduce the number of steps, such as wash and recovery steps, associated with PPS production and/or may reduce the ash content, i.e., impurities, in the recovered PPS. Such a process is disclosed in U.S. Pat. No. 5,352,768, which is hereby incorporated by reference.

For example, an acid or acidic solution may be added to the polymerization reaction mixture under polymerization conditions. The acid or acidic solution may be added after an appreciable amount of polymerization has occurred but prior to termination of the polymerization reaction. Typically, the acid or acidic solution is added immediately prior to the termination of the polymerization reaction. A sufficient amount of acid or acidic solution is added to the polymerization mixture to reduce the basicity of the polymerization mixture. In particular, the mole ratio of acid to PPS will be in the range of 0.025:1 to 0.1:1, with a ratio in the range of 0.4:1 to 0.8:1 being typical.

Organic or inorganic acids which are soluble in or miscible with the polar organic compound or solvent, such as N-methyl-2-pyrrolidone, of the polymerization mixture may be used. Examples of suitable organic acids include, but are not limited to, acetic acid, formic acid, oxalic acid, fumaric acid, and monopotassium phthalic acid. Similarly, suitable inorganic acids include hydrochloric acid, monoammonium phosphate, sulfuric acid, phosphoric acid, boric acid, nitric acid, sodium dihydrogen phosphate, ammonium dihydrogen phosphate, carbonic acid, and H₂SO.

Subsequent to the addition of the acid or acidic solution, the polymerization may be terminated. Termination may be accomplished by allowing the temperature of the polymerization mixture to fall below that at which substantial polymerization occurs, typically below 235° C. After termination of the polymerization reaction the PPS polymers may be recovered by conventional techniques, i.e., filtration, washing, flash recovery, and so forth. The recovered PPS is effectively deionized by the acid treatment such that the recovered PPS constitutes modified PPS which may be employed in conjunction with the techniques described herein.

For example, a PPS polymer may be prepared by treating the polymerization mixture with acid as follows. First, a mixture of 32.40 kg (71.42 lbs.) of a 50% by weight sodium hydroxide (NaOH) aqueous solution with 39.34 kg (86.74 lbs.) of a solution containing 60% by weight sodium hydrosulfide (NaSH) and 0.4% by weight sodium sulfide (Na₂S) may be prepared. This solution, 11.34 kg (25 lbs.) of sodium acetate (NaOAc) powder, and 104.1 L (27.5 gal.) of N-methyl-2-pyrrolidone (NMP) may be added to a stirred (400 rpm) reactor, which may then be purged with nitrogen. This mixture may then be heated to about 172° C. (342° F.) and dehydrated to remove water while the temperature is increased to about 211° C. (411° F.). 63.27 kg (139.49 lbs.) of p-dichlorobenzene (DCB) in 22.7 L (6 gals.) of NMP may be charged to the reactor. The mixture may be heated to about 282° C. (540° F.) and held for 1.5 hours. Then 2,000 mL of glacial acetic acid may be added to the reactor with 3.79 L (1 gal.) of NMP and allowed to react with the reaction mixture for about 5 minutes at 279° C. (535° F.).

The reaction mixture may then be flashed at about 282° C. (540° F.) to remove the NMP and solidify the PPS polymer. The dry, salt-filled polymer may be twice washed with 454.25 L (120 gal.) of deionized water at ambient temperature, then filtered, then washed with 302.83 L (80 gal.) of deionized water at 177° C. (3500 F) for 30 minutes. The solution may be filtered to recover approximately 26.76 kg (59 lbs.) of PPS. The recovered PPS exhibits an ash content of approximately 0.23 or less.

The aforementioned deionization techniques are useful in producing a deionized PPS in which the reactive end-groups have been modified, such as by acidification. However, as one of ordinary skill in the relevant art will appreciate, other deionizing techniques may also be employed which are within the scope of this disclosure. Furthermore, the different deionizing techniques described may be employed separately or in combination. For example, PPS which has been acid treated may subsequently be treated under an organic solvent or with hot water, and so forth.

In addition to deionizing and/or acidifying the PPS, the PPS may also be combined with various additives, such as antioxidants, heat stabilizers, lubricants, nucleating agents, UV stabilizers, carbon black, metal deactivators, plasticizers, titanium dioxide, pigments, clay, mica, flame retardants, processing aids, adhesives, and tackifiers, in amounts which do not affect the desired properties of the PPS or resulting PPS-based blends. Various other polymers may also be present in amounts that do not affect the desired properties. Agents that affect crosslinking, such as peroxides, crosslinking accelerants, and/or crosslinking inhibitors, may also be incorporated into the PPS.

The treated PPS, with or without the additives noted above, may be incorporated into a PPS-based blend. In addition to the treated PPS and any desired additives, the PPS-based blend also comprises an olefinic polymer, such as a copolymer or terpolymer. The olefinic polymer may comprise at least 50% by weight of an α-olefin, such as ethylene, propylene, butene-1, and so forth and less than 50% by weight of a glycidyl ester. Examples of glycidyl esters which may be used in the present technique include glycidyl acrylate, glycidyl methacrylate, glycidyl ethacrylate, and so forth. The olefinic polymer may comprise 40% by weight or less of another copolymerizable unsaturated monomer, such as vinyl ether, vinyl acetate, vinyl propionate, methyl acrylate, methyl methacrylate, acrylonitrile, styrene, and so forth.

In addition to the olefinic copolymer, one or more elastomers may be mixed with the PPS. Typically the elastomer or elastomers comprise at least 50% by weight of ethylene. Possible elastomers include, but are not limited to, the respective copolymers of ethylene/propylene, ethylene/butene, ethylene/propylene/diene, and hydrogenated styrene/butadiene/styrene block. Other possible elastomers include copolymers of ethylene with acrylic acid, methacrylic acid or alkyl esters, and/or the metals salts thereof, and polyamide elastomers. As one of ordinary skill in the art will readily apprehend, other copolymers may also be suitable as an elastomer.

In regard to elastomers comprising copolymers of ethylene with acrylic acid, methacrylic acid, and alkyl esters, and the metal salts thereof, an alkyl group is typically selected which has 1 to 5 carbons atoms. Examples of such elastomers include, but are not limited to, ethylene/acrylic acid ester copolymers, such as the respective copolymers of ethylene/methyl acrylate, ethylene/ethyl acrylate, ethylene/propyl acrylate, and ethylene/butyl acrylate. Similarly, examples of suitable ethylene/methacrylic acid ester copolymers include copolymers of ethylene/methyl methacrylate, ethylene/ethyl methacrylate, ethylene/propyl methacrylate, and ethylene/butyl methacrylate. As noted above, the elastomer may also include or consist of copolymers of ethylene/acrylic acid and/or ethylene methacrylic acid. Likewise, the metal salts of the elastomer copolymers, such as the sodium, zinc, potassium, calcium, lithium, aluminum, and magnesium salts, are intended to be encompassed in the general description of the copolymer, as one of ordinary skill in the art will appreciate.

The selected elastomer or elastomers, along with the olefinic copolymer, acidified PPS, and associated additives may be combined to create the PPS-based blend. As noted above, the PPS-based blend comprises about 40 to 95% by weight of the deionized, i.e., acidified, PPS resin, about 5 to 50% by weight of the olefinic copolymer, and about 1 to 20% by weight of the elastomer. In one embodiment, the blend includes less than 10% by weight of the olefinic copolymer. The weight ratio of the olefinic copolymer to the elastomer typically is about 3:1 to about 20:1. The PPS-based blend may also comprise one or more reinforcing agents, as described below, at 400 parts by weight or less for 100 parts by weight of the total of the PPS, olefinic copolymer, and elastomer. If desired, the reinforcing agents may be treated with a coupling agent, such as silane or titanate, prior to incorporation in the PPS-based blend. Examples of reinforcing agents include fibrous reinforcing agents, such as inorganic and carbonaceous fibers, and hollow or solid granular reinforcing agents, such as silicates, metal oxides, carbonates, sulfates, glass beads, silica, boron nitride, silicon carbide, and so forth.

The PPS-based blend may be melt-blended by a variety of techniques familiar to those of ordinary skill in the art. For example, the PPS, olefinic copolymer, the elastomer, and any desired reinforcing agent or agents may be melt-blended under high shear at a temperature above the melting point of the PPS, such as between 280° to 340° C., in an extruder. The constituents may be pre-mixed or may be metered, simultaneously or separately, into the mixing and blending equipment. The resulting mixture may then be pelletized upon extrusion to facilitate transport and future processing.

The PPS-based blend is generally chemically nonreactive, flame resistant, generally impermeable to liquid and/or vapor, and flexible. The flexibility of the PPS-based blend may be evidenced by the elongation at break associated with the blend, i.e., the elongation of a specimen at the moment of rupture expressed as a percentage of the original length. In particular, the PPS-based blend typically has an elongation at break greater than 150%, as is generally desirable for a flexible coating, such as a wire coating. As one of ordinary skill in the art will appreciate, however, the percentage of elastomer or other constituents may be altered based on the desired embodiment to produce other desired elongation at break ranges. For example, a PPS-based blend with an elongation to break between 100% to 150% may be produced using a lower percentage of elastomer. Similarly, a PPS-based blend with an elongation to break between 150% to 200% or greater may be produced using a higher percentage of elastomer.

C. Applications of a Flexible and/or Impact Resistant PPS-Based Blend

1. Coatings for Flexible Substrates

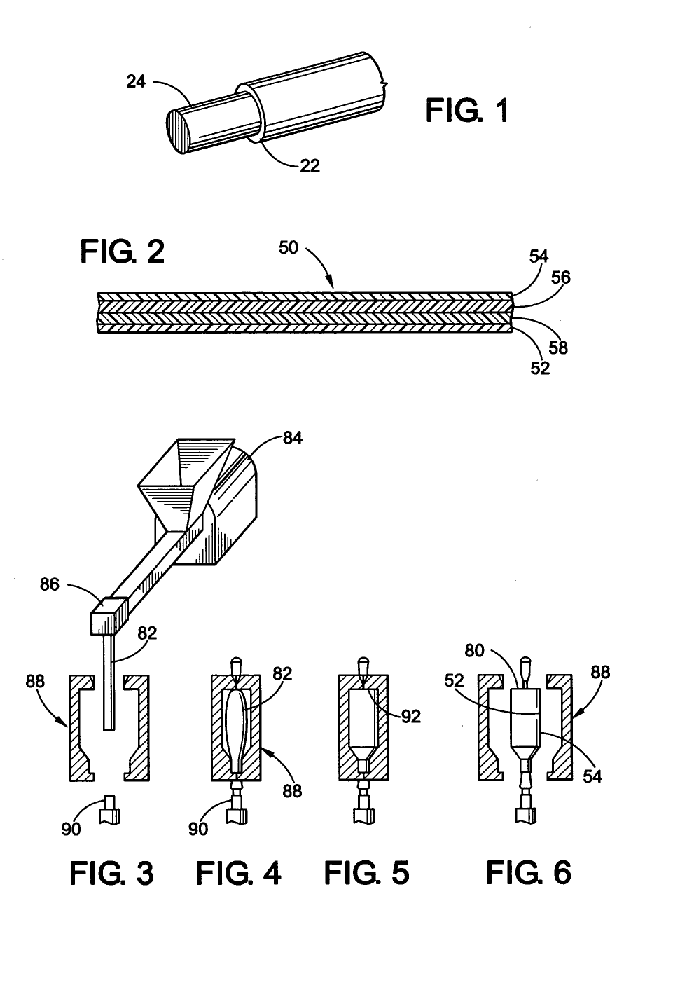

The pelletized PPS-based blend may be used in the construction of commercial or manufactured goods, either as the sole material of construction or as a constituent of a composite construction material. For example, the PPS-based blend may be used as a coating 22 for wires 24 or other flexible media, as depicted in FIG. 1. For example, a mixture of the constituents of the PPS-based blend may be melt blended, such as in an extruder, and subsequently pelletized. The pelletized blend may then be melted and extruded onto the substrate to be coated, such as the wire 24 or a cable, where it may be cooled to harden into a coating 22.

While wires 24 and cables are examples of flexible media which may be coated by the PPS-based blend, other flexible substrates may be similarly coated. For example, a coating comprising a PPS-based blend may be applied to the interior or exterior surfaces of an article, such as a gas tank, chemical drum, kitchen utensil, and so forth. Such surfaces may be inherently flexible due to their composition, and may benefit from a coating of a flexible PPS-based blend. The coating may act as a protective sheathing of the underlying substrate, such as by providing mechanical, chemical, thermal, or electrical protection, while possessing some degree of impact resistance.

Though coatings of other substrates is one possible application of the PPS-based blend, the PPS-based blend itself may be the primary material of construction. For example, single-piece or multi-piece containers or articles may be formed which are chemically non-reactive and/or flame resistant and which possess some degree of flexibility. To construct these articles, the PPS-based blend may be molded or formed by a variety of known techniques, including, but not limited to injection molding, extrusion molding, compression molding, transfer molding, and blow forming.

2. Fibers

The PPS-based blend may also, either alone or in conjunction with other constituents, be formed as strands or fibers. The PPS-blend fibers may in turn be woven into cloth or fabric that may be used to form filters, canvas, clothing, and insulation, such as electrical insulation. For example, the PPS-based blend may be extruded or formed as threads or strands which may comprise the fibers themselves or which may be associated lengthwise, i.e., longitudinally, to form the fibers. Once formed, the PPS-blend fibers may be woven to form a textile, fabric, or cloth, or otherwise associated, such as to form filter material or insulation. Because the fibers are formed from the PPS-based blend, the fibers, and materials made from the fibers, possess greater flexibility and less brittleness relative to pure PPS. The flexibility of the fibers may also depend on the length of PPS polymers comprising the fibers or strands.

3. Multi-Layer Structures

Alternatively, the PPS-blend may be incorporated as one or more layers of a multi-layer structure that possesses additional desired properties or different properties on the exposed surfaces. For example, referring to FIG. 2, a multi-layer structure 50 that incorporates a barrier layer 52 is depicted. The barrier layer 52 may be comprised of: solely PPS, a PPS-based blend as described above; a different thermoplastic, such as polypropylene; or a thermoplastic blend possessing the desired properties, such as vapor impermeability. A barrier layer 52 of PPS or a PPS-based blend may be formed as a solid layer, a film, or finely dispersed particles. As one of ordinary skill in the art will readily apprehend, additional layers of the multi-layer structure 50 may also comprise PPS, either in pure form or as a constituent of a PPS-based blend.

The multi-layer structure 50 may include additional layers that impart impact resistance and/or formability to the multi-layer structure 50. For example, an outer layer 54 may serve as a protective coating. The outer layer 54 also may provide desired structural and/or mechanical properties. The outer layer 54 may be composed of PPS, PPS-based blends, polyethylene (PE), high-density polyethylene (HDPE), polypropylene (PP), nylon, poly(butylene terephthalate) (PBT), poly(ethylene terephthalate) (PET) or other polymers having the desired properties. The outer layer 54 may also comprise a blend of polymers, or it may include a recycled polymer, such as recycled HDPE, that possesses the desired properties.

In addition, as depicted in FIG. 2, a secondary layer 56 may also be included in the multi-layer structure 50. The secondary layer 56 may provide additional protection for the interior layer, such as the barrier layer 52, or it may provide desired structural and/or mechanical properties to the multi-layer structure 50. The secondary layer 56, if present, may therefore have the same or a similar composition as the outer layer 54. Alternatively, the secondary layer 56 may impart different properties to the multi-layer structure 50 than the outer layer 54 and may, therefore, have a different or dissimilar composition based upon the desired properties. Though the multi-layer structure 50 depicted in FIG. 2 is comprised of a limited number of layers for simplicity, the number of layers comprising the structure 50 may be decreased or increased to accommodate the end use. For example, additional layers may be present depending on the chemical, structural, electrical, mechanical, and/or flammability requirements of the multi-layer structure 50 overall.

Based upon the compositions of the barrier layer 52, outer layer 54, and secondary layer 56 (if present), one or more tie layers 58 may be present in the multi-layer structure 50 to facilitate the adhesion of one layer to another. For example, materials such as Xtel® XE3200 (a PPS-based blend available from Chevron Phillips Chemical Company LP) and/or linear low-density polyethylene (LDPE) may be used in the construction of tie layers 58. The composition of a tie layer 58 may be determined by the properties of the adjacent layers, such as the dimensional stability of an adjacent layer over the range of temperatures in the expected environment. For example, a tie layer 58 composed of Xtel® XE3200 may be desirable adjacent a barrier layer 52 composed of PPS or a PPS-based blend. Similarly, a tie layer 58 composed of linear LDPE may be desirable adjacent an outer layer 54 or secondary layer 56 of HDPE or recycled HDPE. If desired, multiple tie layers 58 may be used, as depicted, to accommodate the different compositions of the adjacent layers. In such circumstances, the tie layers 58 may be adhered together along one facing to accomplish the bonding of otherwise dissimilar interior and exterior layers.

The multi-layer structure 50 may be created in a variety of ways in addition to or instead of the incorporation of tie layers 58. For example, the barrier layer 52, outer layer 54, and any additional layers may be subjected to heat and pressure, i.e., lamination, to bond two or more of the layers together. Alternatively the layer surfaces or adhesives disposed between the layers may be activated by an energy source, such as UV, IR, thermal, or plasma, thereby bonding the layers together. As another alternative, a layer of the multi-layer structure 50 may be applied as a laminated film, deposited via spray or plasma spray, or deposited via the evaporation of a solvent to leave a residual layer of solute.

While the aforementioned techniques assume the construction of a multi-layer structure 50 from two or more separate sheets or films composed of the desired polymer or polymer blend, the multi-layer structure 50 may instead be created by a coextrusion or by a multi-layer extrusion process. For example, the multi-layer structure 50 may be constructed by a standard blow molding process, using extrusion, or by injection molding by which layers are sequentially deposited. However, as one of ordinary skill in the art will appreciate, the aforementioned processes are not mutually exclusive and a combination of processes may be utilized in constructing the overall multi-layer structure 50.

a. Creating Components or Articles Using Multi-Layer Structures

Once constructed, the multi-layer structure 50 may be formed, by shaping or molding, into one or more articles or components of interest. Such articles may include containers, such as those used to store and/or transport fuel, chemicals, or beverages, in which the chemical inertness, impermeability, and/or flammability resistance of the interior barrier layer is desirable. For example, a single-piece construction article 80 comprising the multi-layer structure 50 may be constructed using blow molding, as depicted in FIGS. 3 through 6, or via other processes.

Referring to FIG. 3, a multi-layer parison 82, i.e., a molten tube of polymer, is generated by forcing the molten polymer or polymers in an extruder 84 through an annular die 86. The parison 82 descends into a mold 88 with an interior shape in the form of the desired article 80. The mold 88 is closed around the portion of the parison 82 to be molded, as depicted in FIG. 4, and the parison 82 is inflated by an inflow of gas, such as from a gas nozzle 90. The parison 82 is inflated until it conforms to the interior shape of the mold 88, i.e., the shape of the desired article. The article 80 is then cooled, as depicted in FIG. 5, until it is no longer soft and/or malleable. After cooling the article 80 may be ejected from the mold 88 for collection and use. If the parison 82 was multi-layer, the formed article 80 should comprise a multi-layer structure 50. For example, in the simplest context, the article 80 may comprise an inner barrier layer 52, such as a barrier layer 52 of PPS or a PPS-based blend, and an outer layer 54, such as an outer layer 54 comprising HDPE.

While this is one manner in which a single-piece article 80 may be formed from a multi-layer structure 50, in many contexts it may be desirable to construct a multi-piece article 100 from a multi-layer structure 50. For example, it may be desirable to construct fuel or chemical tanks that contain interior components or that are prohibitively large for single piece construction techniques. In these instances, the multi-layer structure 50 may be formed into the desired components, such as body components, fuel filler necks, and so forth, which may be subsequently assembled into the desired multi-piece article 100.

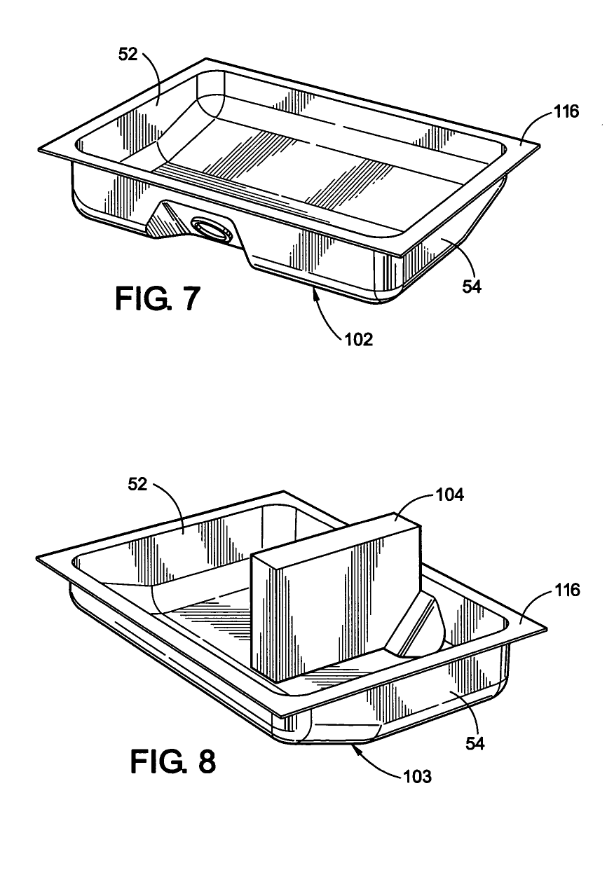

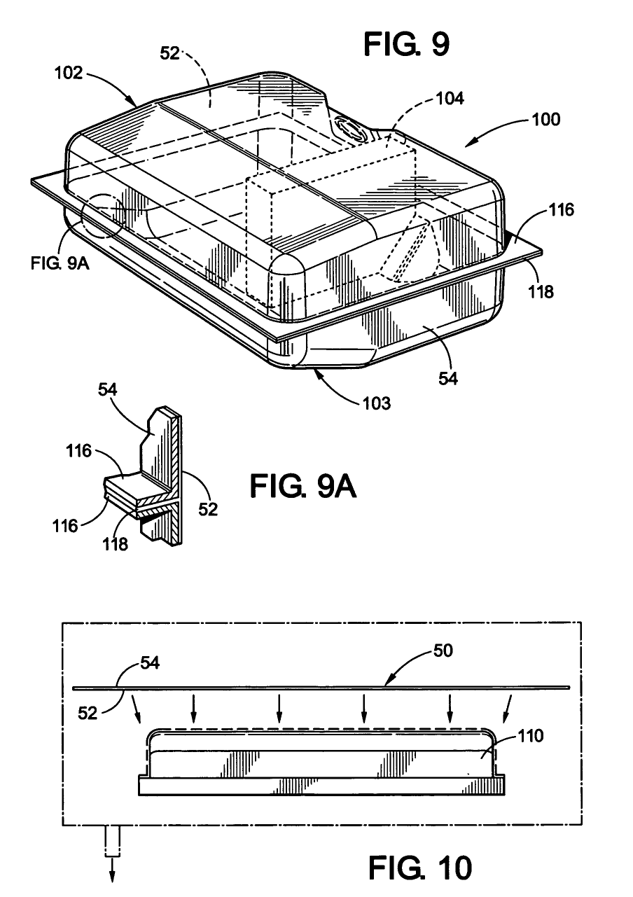

For example, individual components of a multi-piece article 100 may be created by a blow forming process, a variation on the blow molding process depicted in FIGS. 3-6. In the blow forming process, a parison 82 of multi-layer construction is extruded and formed into the desired article. The formed article may be slit into two or more pieces, such as the container half 102 depicted in FIG. 7. The two or more pieces, such as the depicted container top half 102, may be further formed by a forming tool or machine. If desired, internal components 104, such as a fuel pump, fuel level sensor, filter, diverter, splash baffle, and so forth, may be inserted into a container half, such as container bottom half 103, as depicted in FIG. 8, or other piece. As depicted in FIG. 9, the two or more pieces may then be joined to form an impermeable multi-piece article 100, as discussed below, with or without internal components 104. A close-up view of the junction between two pieces of the multi-piece article 100 is depicted in FIG. 9A. The multi-piece article 100 may be trimmed to achieve the desired dimensions or shape.

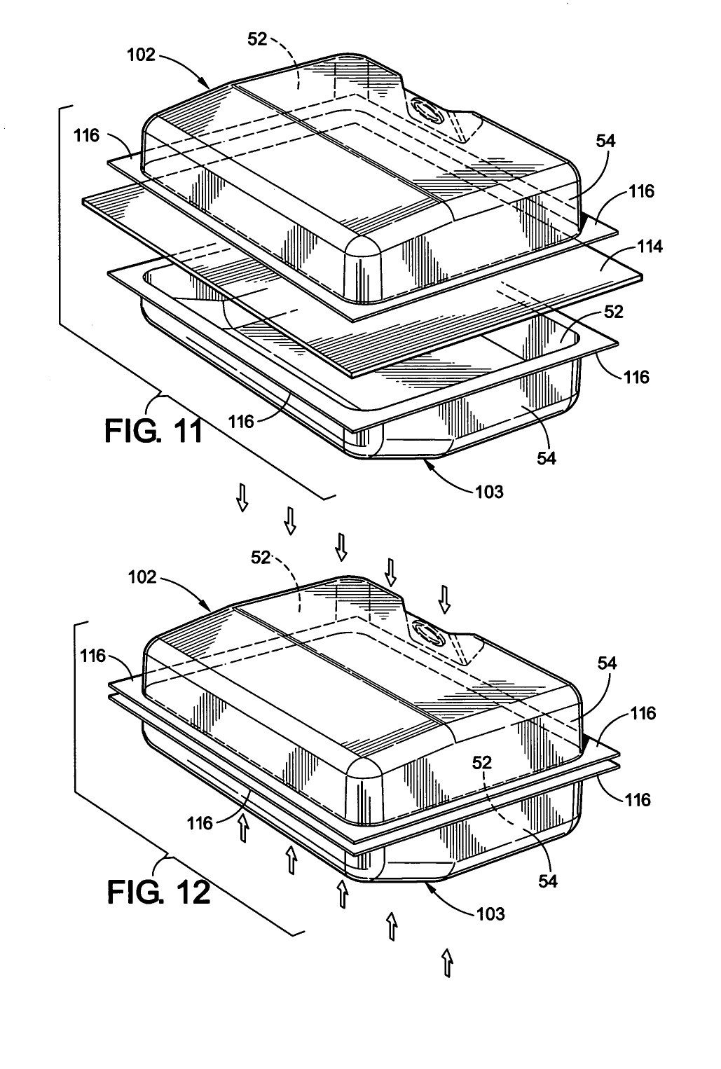

Alternatively, a multi-layer structure 50 may be formed into a container half 102, 103 or other piece of the multi-piece article 100 by other forming processes, such as vacuum forming, as depicted in FIG. 10. In vacuum forming, a vacuum is generated which conforms a malleable multi-layer structure 50 to a mold 110 of the desired shape. For multi-layer structures 50 incorporating one or more layers containing PPS, the vacuum forming process may typically be performed while the structure 50 is still hot and malleable after construction. After the respective pieces of the multi-piece article 100 are vacuum formed, internal components 104 may be inserted into a piece, such as a container half 102, 103 and the pieces joined to form the multi-piece article 100. The multi-piece article 100 may be trimmed to achieve the desired dimensions or shape.

A component of a multi-piece article 100, such as the container half 102, 103, may be formed by other methods as well. For example, the multi-layer structure 50 may be constructed during the forming process, such as in an injection compression molding process. To construct the multi-layer structure 50 in conjunction with forming, the barrier layer 52 may first be inserted, deposited, or applied to the mold as a film, a sheet, a coating of particles, and so forth. The next layer, such as a secondary layer 56, a tie layer, or an outer layer 54, may be applied over the barrier layer 54 via injection compression molding. The heat and pressure of the injection molding process promotes adhesion of the various layers. Additional layers may be similarly applied until the desired component, comprising the multi layer structure 50, is constructed. Once the components of the multi-piece article are formed, assembly of the multi-piece article 100 may proceed as described above, including inclusion of any desired internal components 104. While the forming of components has been described via blow forming, vacuum forming, and injection compression molding, one of ordinary skill in the art will readily apprehend that other forming techniques, such as pressure forming and cold forming, may also be used to form components of a multi-piece article 100.

b. Assembling Multi-Piece Articles

The various components of a multi-piece article 100 may be assembled by a variety of techniques including, but not limited to, hot plate welding, IR or UV activated surfaces or adhesives, EMA bonding, and hot air welding. For example, as depicted in FIG. 11, top and bottom container halves 102, 103 are prepared for hot plate welding. A heated surface 114 is used to heat the complementary surfaces 116 of the respective halves 102, 103 in preparation for joining. Once sufficiently heated, the heated surface 114 may be removed and the complementary surfaces 116 pressed together, as depicted in FIG. 12, creating a fused junction 118 or weld, as depicted in the close-up view of the junction in FIG. 9A. As noted above, the article 100 may be trimmed to achieve the desired critical dimensions after the assembly process.

As depicted in FIG. 9A, if the components of the multi-piece article 100, such as container halves 102, 103, have been constructed such that the barrier layer 52 is disposed on the interior of the article 100, the complementary surfaces 116 will be comprised of the barrier layer 52. The fusion or welding of the barrier layer 52 in this manner results in a fused junction 118 or weld comprising the barrier material, such as PPS or a PPS-based blend, with the impermeable properties of the barrier layer 52. In this manner, a junction 118 or weld that is permeable to the liquid or vapors to be contained may be avoided.

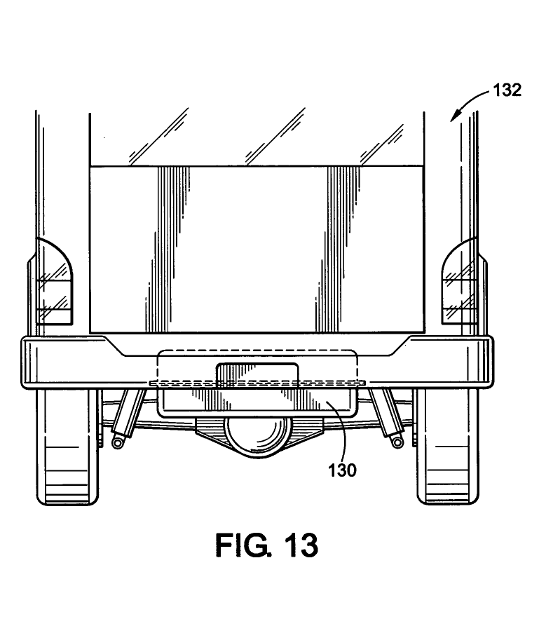

While the multi-piece article 100 has been depicted in the present discussion as a two-piece container for simplicity, one of ordinary skill in the art will readily apprehend that the technique may be readily adapted to articles 100 possessing more pieces or more complex pieces. Indeed, the economics of tooling and the build volumes will typically determine the number of components of a multi-piece article 100, and the present technique may be readily adapted for use with more complex multi-piece articles 100. For example, fuel tanks 130 may be formed and incorporated into motor vehicles 132, such as cars, trucks, motorcycles, boats, aircraft, and so forth, as depicted in FIG. 13, such that fuel for the engine of the vehicle may be stored in the fuel tank 130. A fuel tank 130 constructed by the present technique may possess the benefit of being impermeable or substantially impermeable to fuel vapors through the fused junction 118 formed between the assembled parts. Such fuel tanks 130 may comprise a PPS or PPS blend barrier layer 52 and one or more HDPE impact layers, i.e., outer layers 54 and/or secondary layers 56, as well as any desired tie layers 58. As one of ordinary skill in the art will recognize, other barrier materials and layer materials may also be employed, depending on the structural, mechanical, and impermeability properties desired. Similarly, other chemical containers of various shapes and sizes may be constructed using the disclosed technique.

Though the preceding discussion focuses primarily on the possibility of using multi-layer structures comprising one or more layers of PPS or PPS-based layers to form either single- or multi-piece articles, a single layer of PPS may be similarly employed. For example, a container or fuel tank may be constructed of a single layer of PPS or a multi-layer structure in which the assorted layers are PPS or PPS-based blends. Such a container or fuel tank would have the impermeability characteristics as described above if constructed in accordance with the above techniques, i.e., forming an impermeable weld or junction 118 of PPS or PPS-based blends. The respective PPS components may be formed by the techniques described above, such as blow-forming, vacuum forming, and so forth and may be assembled by the disclosed techniques, such as hot plate welding or hot air welding.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A composition, comprising:
about 5% to about 50% by weight of an olefinic polymer comprising ethylene and a glycidyl ester;
about 40% to about 95% by weight of an acidified PPS; and
about 1% to about 20% by weight of an elastomer comprising copolymers of ethylene and at least one of an acrylic acid, a methacrylic acid, an alkyl ester in which the alkyl group has 1 to 5 carbon atoms, and respective metal salts thereof;
wherein the weight ratio of the olefinic polymer to the elastomer ranges from about 3:1 to about 20:1.

2. The composition as recited in claim 1, wherein the acidified PPS has a sodium ion content of less than 900 ppm.

3. The composition as recited in claim 1, wherein the composition has an elongation at break greater than 150%.

4. The composition as recited in claim 1, wherein the acidified PPS is combined with at least one of an antioxidant, a heat stabilizer, a lubricant, a nucleating agent, a UV stabilizer, carbon black, a metal deactivator, a plasticizer, titanium dioxide, a pigment, clay, mica, a flame retardant, a processing aid, an adhesive, and a tackifier.

5. The composition as recited in claim 1, wherein the acidified PPS is combined with one or more reinforcing agents.

6. The composition as recited in claim 1, wherein the composition comprises less than 10% by weight of the olefinic polymer.

7. A method for producing a PPS-based blend, comprising the acts of:
reacting a polymerization mixture comprising at least one sulfur source, at least one dihaloaromatic compound, and a polar organic compound under polymerization conditions to produce a PPS-polymer;
acidifying one or more endgroups of the PPS polymer to produce an acidified PPS polymer;
terminating the polymerization reaction;
recovering the acidified PPS-polymer; and
blending the acidified PPS-polymer, an olefinic polymer of at least ethylene and a glycidyl ester, and an elastomer comprising copolymers of ethylene and at least one of an acrylic acid, a methacrylic acid, an alkyl ester in which the alkyl group has 1 to 5 carbon atoms and respective metal salts thereof, at a temperature greater than the melting point of the acidified PPS-polymer to produce a PPS-based blend, wherein the weight ratio of the olefinic polymer and the elastomer ranges from about 3:1 to about 20:1.

8. The method as recited in claim 7, wherein acidifying the one or more endgroups occurs prior to terminating the polymerization reaction.

9. The method as recited in claim 7, wherein acidifying the one or more endgroups occurs under polymerization conditions.

10. The method as recited in claim 7, wherein acidifying the one or more endgroups occurs subsequent to recovering the PPS-polymer.

11. The method as recited in claim 7, comprising pelletizing the PPS-based blend.

12. The method as recited in claim 7, wherein one or more reinforcing agents are blended with the acidified PPS-polymer, the olefinic coploymer, and the elastomer.

13. The method as recited in claim 7, wherein the PPS-based blend comprises about 5% to about 50% by weight of the olefinic copolymer.

14. The method as recited in claim 7, wherein the PPS-based blend comprises less than 10% by weight of the olefinic copolymer.

15. The method as recited in claim 7, wherein the PPS-based blend comprises about 40% to about 90% by weight of the acidified PPS.

16. The method as recited in claim 7, wherein the PPS-based blend comprises about 1% to about 20% by weight of the elastomer.

17. A PPS-blend fiber comprising:
a plurality of strands, wherein each strand comprises:
about 5% to about 50% by weight of an olefinic polymer of at least ethylene and a glycidyl ester;
about 40% to about 95% by weight of an acidified PPS; and
about 1% to about 20% by weight of an elastomer comprising copolymers of ethylene and at least one of an acrylic acid, a methacrylic acid, an alkyl ester in which the alkyl group has 1 to 5 carbon atoms, and respective metal salts thereof;
wherein the weight ratio of the olefinic polymer to the elastomer ranges from about 3:1 to about 20:1.

18. The PPS-blend fiber of claim 17, wherein the acidified PPS has a sodium ion content of less than 900 ppm.

19. The PPS-blend fiber of claim 17, wherein the acidified PPS is combined with at least one of an antioxidant, a heat stabilizer, a lubricant, a nucleating agent, a UV stabilizer, carbon black, a metal deactivator, a plasticizer, titanium dioxide, a pigment, clay, mica, a flame retardant, a processing aid, an adhesive, and a tackifier.

20. The PPS-blend fiber of claim 17, wherein the acidified PPS is combined with one or more reinforcing agents.

21. The PPS-blend fiber of claim 17, wherein the strands comprise less than 10% by weight of the olefinic polymer.

22. A coated article, comprising:
a deformable substrate;
a coating disposed about one or more surfaces of the deformable substrate, the coating comprising:
about 5% to about 50% by weight of an olefinic polymer comprising ethylene and a glycidyl ester;
about 40% to about 95% by weight of an acidified PPS; and
about 1% to about 20% by weight of an elastomer comprising copolymers of ethylene and at least one of an acrylic acid, a methacrylic acid, an alkyl ester in which the alkyl group has 1 to 5 carbon atoms, and respective metal salts thereof;
wherein the weight ratio of the olefinic polymer to the elastomer ranges from about 3:1 to about 20:1.

23. The coated article as recited in claim 22, wherein the acidified PPS has a sodium ion content of less than 900 ppm.

24. The coated article as recited in claim 22, wherein the coating has an elongation at break greater than 150%.

25. The coated article as recited in claim 22, wherein the acidified PPS is combined with at least one of an antioxidant, a heat stabilizer, a lubricant, a nucleating agent, a UV stabilizer, carbon black, a metal deactivator, a plasticizer, titanium dioxide, a pigment, clay, mica, a flame retardant, a processing aid, an adhesive, and a tackifier.

26. The coated article as recited in claim 22, wherein the acidified PPS is combined with one or more reinforcing agents.

27. The coated article as recited in claim 22, wherein the coating comprises less than 10% by weight of the olefinic polymer.

28. A multi-layer structure, comprising:
at least one base layer; and
a barrier layer disposed on the at least one base layer, the barrier layer comprising:
about 5% to about 50% by weight of an olefinic polymer of at least ethylene and a glycidyl ester;
about 40% to about 95% by weight of an acidified PPS; and
about 1% to about 20% by weight of an elastomer comprising copolymers of ethylene and at least one of an acrylic acid, a methacrylic acid, an alkyl ester in which the alkyl group has 1 to 5 carbon atoms, and respective metal salts thereof;
wherein the weight ratio of the olefinic polymer to the elastomer ranges from about 3:1 to about 20:1.

29. The multi-layer structure as recited in claim 28, wherein the base layer comprises an outer layer.

30. The multi-layer structure as recited in claim 28, wherein the multi-layer structure comprises a container comprising an interior surface and an exterior surface.

31. The multi-layer structure as recited in claim 30, wherein the barrier layer forms the interior surface and the base layer forms the exterior surface.

32. The multi-layer structure as recited in claim 28, comprising one or more tie layers disposed between the barrier layer and the base layer.

33. The multi-layer structure as recited in claim 28, wherein at least one tie layer comprises at least one of Xtel XE3200 and linear low-density polyethylene.

34. The multi-layer structure as recited in claim 28, wherein the base layer comprises at least one of polyethylene, high-density polyethylene, polypropylene, nylon, poly(butylene terephthalate), poly(ethylene terephthalate).

35. The multi-layer structure as recited in claim 28, wherein the barrier layer comprises one of a film, a solid layer, and a dispersion of particles.

36. The multi-layer structure as recited in claim 28, comprising one or more secondary layers disposed between the barrier layer and the base layer.

37. The multi-layer structure as recited in claim 28, wherein the acidified PPS is combined with at least one of an antioxidant, a heat stabilizer, a lubricant, a nucleating agent, a UV stabilizer, carbon black, a metal deactivator, a plasticizer, titanium dioxide, a pigment, clay, mica, a flame retardant, a processing aid, an adhesive, and a tackifier.

38. The multi-layer structure as recited in claim 28, wherein the barrier layer comprises one or more reinforcing agents.

39. The multi-layer structure as recited in claim 28, wherein the barrier layer comprises less than 10% by weight of the olefinic polymer.

40. A vapor impermeable structure, comprising:
at least two structure components formed from a composite sheet, the composite sheet comprising:
a barrier layer;
an outer layer;
at least one vapor impermeable seal between an adjoining two of the structure components, the vapor impermeable seal comprising a fused region formed from the fusion of the barrier layer of the respective adjoining structure components.

41. The vapor impermeable structure as recited in claim 40, wherein the barrier layer comprises:
about 5% to about 50% by weight of an olefinic copolymer of ethylene and a glycidyl ester;
about 40% to about 90% by weight of an acidified PPS; and
about 1% to about 20% by weight of an elastomer comprising copolymers of ethylene and at least one of an acrylic acid, a methacrylic acid, an alkyl ester in which the alkyl group has 1 to 5 carbon atoms, and respective metal salts thereof;
wherein the weight ratio of the olefinic polymer to the elastomer ranges from about 3:1 to about 20:1.

42. The vapor impermeable structure as recited in claim 41, wherein the barrier layer comprises less than 10% by weight of the olefinic copolymer

43. The vapor impermeable structure as recited in claim 40, wherein the composite sheet comprises one or more tie layers disposed between the barrier layer and the outer layer.

44. The vapor impermeable structure as recited in claim 43, wherein at least one tie layer comprises at least one of Xtel XE3200 and linear low-density polyethylene.

45. The vapor impermeable structure as recited in claim 40, wherein the outer layer comprises at least one of polyethylene, high-density polyethylene, polypropylene, nylon, poly(butylene terephthalate), poly(ethylene terephthalate).

46. The vapor impermeable structure as recited in claim 40, wherein the barrier layer comprises one of a film, a solid layer, and a dispersion of particles.

47. The vapor impermeable structure as recited in claim 40, wherein the composite sheet comprises one or more secondary layers disposed between the barrier layer and the outer layer.

48. The vapor impermeable structure as recited in claim 40, wherein the barrier layer comprises at least one of an antioxidant, a heat stabilizer, a lubricant, a nucleating agent, a UV stabilizer, carbon black, a metal deactivator, a plasticizer, titanium dioxide, a pigment, clay, mica, a flame retardant, a processing aid, an adhesive, and a tackifier.

49. The vapor impermeable structure as recited in claim 40, wherein the barrier layer comprises one or more reinforcing agents.

50. A vapor impermeable component, comprising:
a component body formed from a composite sheet, the composite sheet comprising:
a barrier layer; and
an outer layer;
wherein at least one edge of the component body conforms to a mating edge of a second component such that the barrier layers of the component body and the second component can be joined.

51. The vapor impermeable component as recited in claim 50, wherein barrier layer comprises:
about 5% to about 50% by weight of an olefinic copolymer of ethylene and a glycidyl ester;
about 40% to about 90% by weight of an acidified PPS; and
about 1% to about 20% by weight of an elastomer comprising copolymers of ethylene and at least one of an acrylic acid, a methacrylic acid, an alkyl ester in which the alkyl group has 1 to 5 carbon atoms, and respective metal salts thereof;
wherein the weight ratio of the olefinic polymer to the elastomer ranges from about 3:1 to about 20:1.

52. The vapor impermeable component as recited in claim 51, wherein barrier layer comprises less than 10% by weight of the olefinic copolymer.

53. The vapor impermeable component as recited in claim 50, wherein the composite sheet comprises one or more tie layers disposed between the barrier layer and the outer layer.

54. The vapor impermeable component as recited in claim 53, wherein at least one tie layer comprises at least one of Xtel XE3200 and linear low-density polyethylene.

55. The vapor impermeable component as recited in claim 50, wherein the outer layer comprises at least one of polyethylene, high-density polyethylene, polypropylene, nylon, poly(butylene terephthalate), poly(ethylene terephthalate).

56. The vapor impermeable component as recited in claim 50, wherein the barrier layer comprises one of a film, a solid layer, and a dispersion of particles.

57. The vapor impermeable component as recited in claim 50, wherein the composite sheet comprises one or more secondary layers disposed between the barrier layer and the outer layer.

58. The vapor impermeable component as recited in claim 50, wherein the barrier layer comprises at least one of an antioxidant, a heat stabilizer, a lubricant, a nucleating agent, a UV stabilizer, carbon black, a metal deactivator, a plasticizer, titanium dioxide, a pigment, clay, mica, a flame retardant, a processing aid, an adhesive, and a tackifier.

59. The vapor impermeable component as recited in claim 50, wherein the barrier layer comprises one or more reinforcing agents.

60. A fuel tank, comprising:
a fuel tank body defining a fuel tank interior, the fuel tank body comprising:
two or more body components, each formed from a respective composite sheet, each respective composite sheet comprising:
a barrier layer
an outer layer; and
at least one vapor impermeable seal between an adjoining two of the body components, the vapor impermeable seal comprising a fused region formed from the fusion of the barrier layer of the respective adjoining body components.

61. The fuel tank as recited in claim 60 comprising one or more interior components disposed within the fuel tank interior.

62. The fuel tank as recited in claim 61, wherein the one or more interior components comprise at least one of a pump, a filter, and a diverter.

63. The fuel tank as recited in claim 60, wherein barrier layer comprises:
about 5% to about 50% by weight of an olefinic copolymer of ethylene and a glycidyl ester;
about 40% to about 90% by weight of an acidified PPS; and
about 1% to about 20% by weight of an elastomer comprising copolymers of ethylene and at least one of an acrylic acid, a methacrylic acid, an alkyl ester in which the alkyl group has 1 to 5 carbon atoms, and respective metal salts thereof;
wherein the weight ratio of the olefinic polymer to the elastomer ranges from about 3:1 to about 20:1.

64. The fuel tank as recited in claim 63, wherein barrier layer comprises less than 10% by weight of the olefinic copolymer.

65. The fuel tank as recited in claim 60, wherein the composite sheet comprises one or more tie layers disposed between the barrier layer and the outer layer.

66. The fuel tank as recited in claim 65, wherein at least one tie layer comprises at least one of Xtel XE3200 and linear low-density polyethylene.

67. The fuel tank as recited in claim 60, wherein the outer layer comprises at least one of polyethylene, high-density polyethylene, polypropylene, nylon, poly(butylene telephthalate), poly(ethylene terephthalate).

68. The fuel tank as recited in claim 60, wherein the barrier layer comprises one of a film, a solid layer, and a dispersion of particles.

69. The fuel tank as recited in claim 60, wherein the composite sheet comprises one or more secondary layers disposed between the barrier layer and the outer layer.

70. The fuel tank as recited in claim 60, wherein the barrier layer comprises at least one of an antioxidant, a heat stabilizer, a lubricant, a nucleating agent, a UV stabilizer, carbon black, a metal deactivator, a plasticizer, titanium dioxide, a pigment, clay, mica, a flame retardant, a processing aid, an adhesive, and a tackifier.

71. The fuel tank as recited in claim 60, wherein the barrier layer comprises one or more reinforcing agents.

72. The fuel tank as recited in claim 60, comprising a filler neck allowing access to the fuel tank interior space.
